(19) United States
(12) Patent Application Publication
(10) Pub. No.: US 2010/0158008 A1
(43) Pub. Date: Jun. 24, 2010

(54) SWITCHING EXCHANGE

(75) Inventors: Shinsuke SHIMIZU, Yokohama (JP); Hiroaki MIYATA, Yokohama (JP); Minoru NAGAI, Fujisawa (JP); Yusuke HONDA, Kawasaki (JP)

Correspondence Address: MATTINGLY & MALUR, P.C., 1800 DIAGONAL ROAD, SUITE 370, ALEXANDRIA, VA, 22314, US

(73) Assignee: HITACHI, LTD., Tokyo (JP)

(21) Appl. No.: 12/577,756

(22) Filed: Oct. 13, 2009

(30) Foreign Application Priority Data
Dec. 24, 2008 (JP) 2008-326792

(51) Int. Cl. H04L 12/56

(52) U.S. Cl. 370/392

(57) ABSTRACT

In a network system where a switching exchange accommodating an ISDN provides TDMoIP packet communication over an IP network, measures for packet loss prevention need to be taken during a period during which a TDM service is packet-transferred over the IP network. When a transmitting-end switching exchange in the above network system multiplexes TDM data, the present invention varies the degree of multiplicity in accordance with the delay in the IP network and the type of data.

### INCORPORATION BY REFERENCE

The present application claims priority from Japanese applications JP2008-326792 filed on Dec. 24, 2008, the content of which is hereby incorporated by reference into this application.

### BACKGROUND OF THE INVENTION

The present invention relates to a technology for providing improved reliability and enhanced efficiency when TDMoIP packet loss occurs in an IP network in a situation where a network system and a switching exchange are used to handle both an ISDN and an IP network.

TDM (Time Division Multiplexing) over IP (hereinafter referred to as TDMoIP) achieves PRI (Primary Rate Interface) transmission, T1 transmission, and E1 transmission over an IP-based network or Ethernet (registered trademark)-based network.

A TDMoIP transmission technology mainly involves the use of two different methods. One method is to replace a TDM network and an end-user device entirely with a communication device provided with mechanisms for voice transmission and signaling. The other method is to tunnel TDM data through a packet network by using an existing PBX (Private Branch eXchange) and multiplexer as they are. Business enterprises expect existing devices to make use of an IP network with a view toward taking advantage of cost reduction by integrating their own voice and data networks without squandering the investment in a conventional PBX or TDM device.

In an apparatus that can use an existing PBX and multiplexer as they are, TDM clock jitter and wander are strictly defined for a TDM-based device. Therefore, synchronism is maintained with an extremely small delay. Meanwhile, when an IP-based packet method is used, packet delay and packet loss occur due to a conflict with bandwidth and router ports. A source device transmits packets at regular intervals over a network. However, the network does not guarantee that the packets will be delivered to a destination device at the same intervals or in the same sequence. In some cases, the packets will not be delivered to the destination device.

An ISDN (Integrated Services Digital Network) is no exception. It is anticipated that packet loss may also occur due to the connection of the aforementioned IP network in a situation where the IP network is integrated with an existing ISDN. When packet loss occurs, for example, the quality of communication between telephone terminals deteriorates. Measures for packet loss prevention during a packet transfer period of an IP network have been studied (as described, for instance, in JP-A-2007-60345) because they need to be taken when an ISDN, which is a TDM service, is to be integrated into an IP-based network.

The technology described in JP-A-2007-60345 packetizes a data stream in a network where a data stream is transmitted and received, copies the packets, and transmits the packets in multiple sessions. If a receiving end has a copied packet (having the same sequence number as another packet), which is copied in accordance with an RTP (Real Time Protocol) sequence number in a packet, such a copied packet is discarded. If only a copied packet has arrived at the receiving end due to packet loss, such a packet is decoded into a data stream.

### SUMMARY OF THE INVENTION

The technology described in JP-A-2007-60345 makes multiple copies of packets which are data identical with each other. Thus, the copied packets are also equal in a destination address and other items of information within an IP header. Therefore, these packets are routed along the same path. The packets can be retransmitted by predefining the number of transmissions and the transmission intervals. Further, it is possible to prevent packet loss due to bursty high traffic. However, if the path becomes physically defective, packet loss may occur because the packets cannot be recovered. In addition, an IP header is attached to an RTP packet, which is small in data size. Therefore, particularly when multiple copies are made, it is anticipated that poor bandwidth efficiency may result because the header size is relatively larger than the data size. There is a trade-off between bandwidth efficiency and packet recovery technology.

To solve the above-described conventional problem and recover TDMoIP packets, the degree of multiplicity is varied with the delay in an IP network and the amount of TDM data to be transmitted. This increases the transfer efficiency and the bandwidth efficiency of low-delay transfer in consideration of bandwidth conditions. Further, generation copies obtained by multiplexing TDM data are used instead of mere packet copies. Therefore, IP headers are not duplicated so that TDMoIP packets are unfailingly delivered to a receiving-end switching exchange even if a trouble occurs in the same path. Consequently, it is possible to provide a technology for recovering TDMoIP packets even when packet loss occurs in an IP network.

According to one aspect of the present invention, there is provided a network system including: a transmitter for transmitting packet data, which is obtained by packetizing time-division-multiplexed data, to a network; and a receiver for receiving the packet data. The transmitter includes a first memory section for storing segment data, which is obtained by segmenting the time-division-multiplexed data; a control section for controlling the generation of duplicate data from the segment data; a first packet processing section for multiplexing the segment data and converting the multiplexed segment data to packet data; and a transmission section for transmitting the packet data to the network. The receiver includes a reception section for receiving the packet data and a second packet processing section for converting the received packet data to time-division-multiplexed data.

According to another aspect of the present invention, there is provided a communication method for using a transmitter for transmitting packet data, which is obtained by packetizing time-division-multiplexed data, to a network; a receiver for receiving the packet data; and a network for connecting the transmitter and the receiver, the communication method including the steps of: segmenting the time-division-multiplexed data received by the transmitter; storing the resulting segment data in a first memory section; reading the segment data from the first memory section and generating duplicate data; causing a first packet processing section to multiplex the segment data and convert the multiplexed segment data to packet data; transmitting the packet data from the transmitter to the network; and causing a second packet processing section to convert the packet data, which is received by the receiver through the network, to time-division-multiplexed data.

When the TDM data is to be converted to IP packets, a transmitting-end switching exchange may store the data in a TDMoIP packet payload section with the data size of a data queue section. Further, the size of the TDM data may be rendered variable as desired by data queue control provided by the data queue section. Furthermore, when a TDMoIP packet processing section converts the TDM data to IP packets, the TDM data may be multiplexed and stored in the TDMoIP packet payload section. Moreover, when the TDM data is to be multiplexed, the degree of multiplicity may be varied with the type of TDM data and the delay time of the IP network.

A protocol identification section may be rendered capable of identifying the type of TDM data. Further, a data management table in a memory may be rendered capable of calculating the delay time of the IP network from the timestamp of a TDMoIP packet and the time of TDMoIP reception by a receiving-end switching exchange.

A delay information packet generation section may transmit a delay information packet indicative of the delay time to the transmitting-end switching exchange and use the delay information packet to vary the degree of multiplicity. Further, the receiving-end switching exchange may reassemble TDM data from TDMoIP packets by causing the TDMoIP packet processing section to compensate for lost packets when packet loss occurs and discard redundant TDMoIP payload data when no packet loss occurs. Moreover, the TDMoIP packet processing section may discard redundant TDMoIP payload data when a duplicate sequence number is revealed by TDMoIP header information.

When TDMoIP packet loss occurs in an IP network in a situation where a network system and a switching exchange are used to handle both an ISDN and an IP network, the present invention makes it possible to provide enhanced reliability in packet recovery by making generation copies of TDM data and increase the transfer efficiency and the bandwidth efficiency of low-delay transfer in consideration of the delay in the IP network and the type of TDM data.

### BRIEF DESCRIPTION OF THE DRAWINGS

FIG. 1 is a diagram illustrating a communication system that represents an exemplary basic embodiment of the present invention.

FIG. 2 is a block diagram illustrating a switching exchange according to the present invention.

FIG. 3 is a diagram illustrating a transmitting-end data management table.

FIG. 4 is a diagram illustrating a receiving-end data management table.

FIG. 5 is a diagram illustrating a sequence number comparison table.

FIG. 6 is a diagram illustrating a data queue.

FIG. 7 is a diagram illustrating a TDMoIP packet.

FIG. 8 is a diagram illustrating a delay information packet.

FIGS. 9(1) to 9(5) are diagrams illustrating an operation performed by a transmitting-end switching exchange according to a first embodiment of the present invention.

FIG. 10 is a flowchart illustrating an operation performed by the transmitting-end switching exchange according to the first embodiment and second embodiment of the present invention.

FIGS. 11(1) to 11(5) are diagrams illustrating an operation performed by a receiving-end switching exchange according to the first embodiment of the present invention.

FIG. 12 is a flowchart illustrating an operation performed by the receiving-end switching exchange according to the first embodiment of the present invention.

FIG. 13 is a diagram illustrating a sequence number comparison table for use in the first embodiment of the present invention.

FIGS. 14(1) to 14(4) are diagrams illustrating a delay information packet and an operation performed by a transmitting-end switching exchange according to a second embodiment of the present invention.

FIG. 15 is a diagram illustrating a transmitting-end data management table for use in the second embodiment of the present invention.

FIG. 16 is a diagram illustrating a receiving-end data management table for use in the second embodiment of the present invention.

FIGS. 17(1) to 17(3) are diagrams illustrating an operation performed by the transmitting-end switching exchange according to the second embodiment of the present invention.

FIG. 18 is a diagram illustrating a sequence number comparison table for use in the second embodiment of the present invention.

### DESCRIPTION OF THE PREFERRED EMBODIMENTS

Embodiments of the present invention will be described below in detail with reference to the accompanying drawings.

### First Embodiment

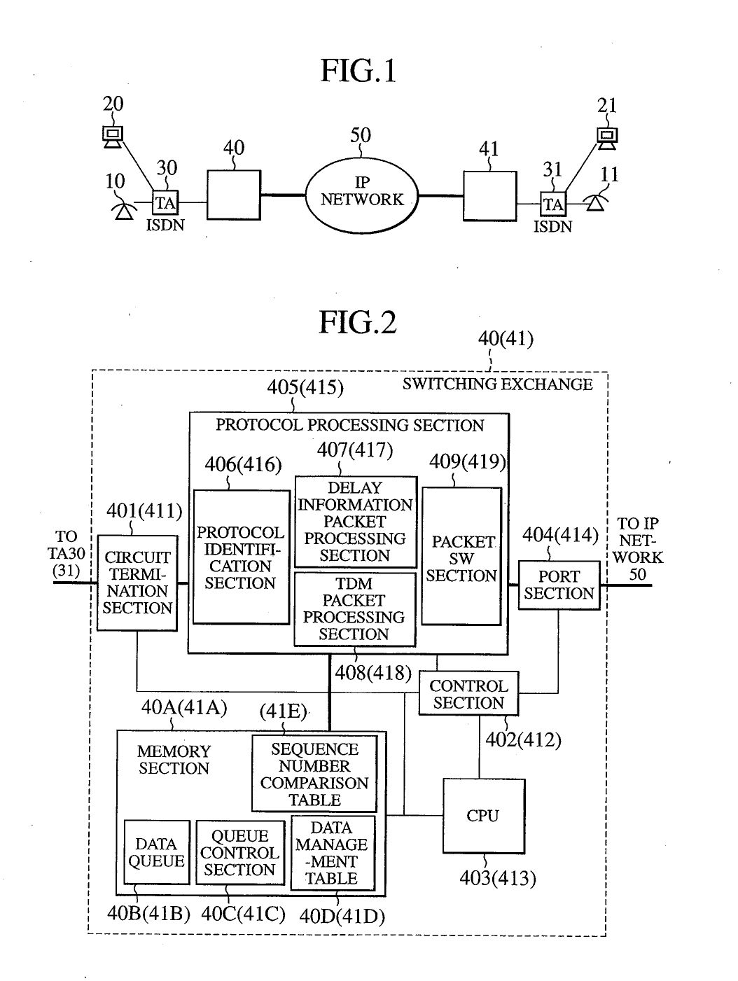

A first embodiment of the present invention will now be described. FIG. 1 is an overall view of a communication system in which a switching exchange 40 (41) is used. The switching exchange 40 (41) is used for a subscriber and connected to an ISDN line to which a telephone terminal 10 (11) and a PC terminal 20 (21) are connected through a terminal adapter 30 (31) (connection/signal conversion device). The terminal adapter 30 (31) is hereinafter referred to as the TA 30 (31).

Various data are handled by the telephone terminal 10 and PC terminal 20. For example, the telephone terminal 10 handles continuous voice data and the PC terminal 20 handles single-shot data for email transmission/reception. All such data are passed through the TA 30 and converted to IP packets in the transmitting-end switching exchange 40. These IP packets are handled as TDMoIP packets 1000, passed through an IP network 50, converted to TDM data in the receiving-end switching exchange 41, and forwarded to the telephone terminal 11 and PC terminal 21 through the TA 31. These steps are performed to provide a conversation between the telephone terminal 10 and telephone terminal 11 and email transmission/reception between the PC terminal 20 and PC terminal 21.

FIG. 2 is a diagram illustrating the configuration of the switching exchange 40 (41). Data transmitted from the telephone terminal 10 (11) and PC terminal 20 (21) is forwarded to the TA 30 (31), passed through an ISDN line, and terminated by a circuit termination section 401 (411). This data is TDM data and transmitted in the form of a continuous frame. The circuit termination section 401 (411) is controlled by a CPU 403 (413) and a control section 402 (412). To determine whether the TDM data is voice data of a telephone or the like or common data such as email data, a protocol identification section 406 identifies the protocol of the TDM data.

When voice data is handled, the degree of multiplicity, which will be described later, is decreased in consideration of delay. When, on the other hand, email data or other common data is handled, the degree of multiplicity is increased to enhance the transfer efficiency and the bandwidth efficiency of low-delay transfer.

A TDM packet processing section 408 (418) converts the TDM data to IP packets. The TDMoIP packets 1000 are transmitted to the IP network 50 through a packet transmission configuration (a packet SW section 409 (419) and a port section 404 (414)). All the above steps are common to the transmitting-end switching exchange 40 and receiving-end switching exchange 41.

The following description applies to the transmitting-end switching exchange 40 only. The data to be converted to TDMoIP packets is temporarily queued in a data queue 40B in a memory section 40A. Data queues can be set up as desired. The number of data queues that are set represents the number of generations of copies. A data queue control section 40C controls the generation copies (duplicates) in the data queues.

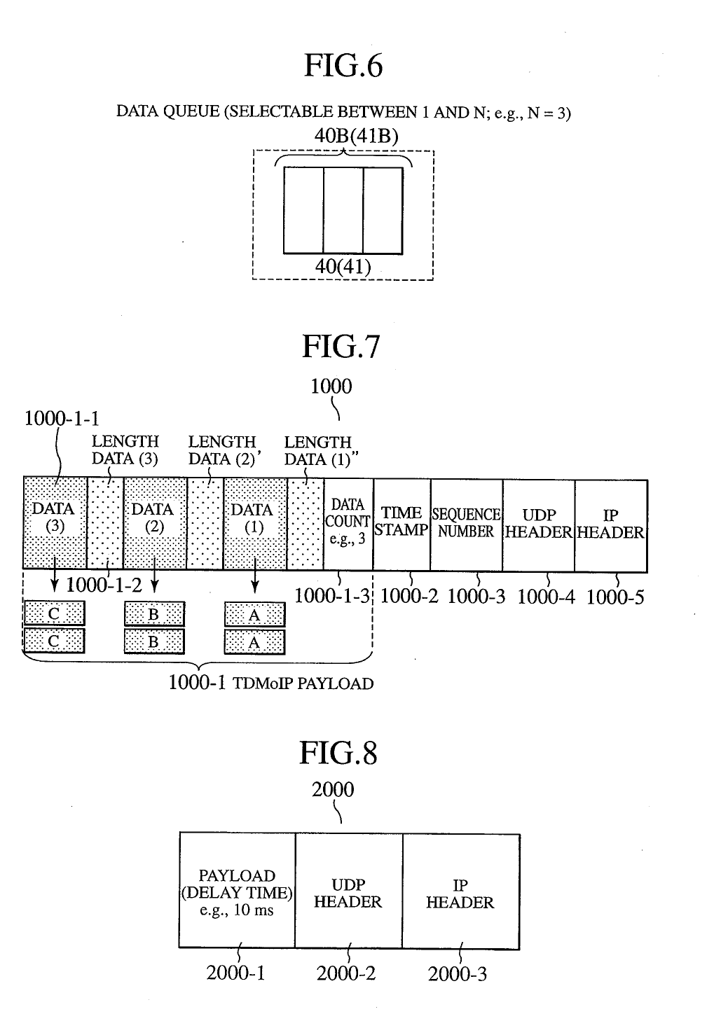

Next, the TDM data needs to be multiplexed before being converted to TDMoIP packets. The degree of multiplicity is determined in accordance with the type of data as described earlier or determined in accordance with delay in the IP network as described later. Multiplexing is provided by the TDM packet processing section 408. The degree of multiplicity is determined on the basis of a data management table 40D in the memory section 40A. Multiplexed TDM data is stored in a TDMoIP payload section 1001 which will be described later with reference to FIG. 6. An IP header 1005, a UDP header 1004, a timestamp 1003, and a sequence number 1002 are attached to the payload section to generate a TDMoIP packet 1000. The TDMoIP packet 1000 is transmitted over the IP network 50 to the receiving-end switching exchange 41 via the packet SW section 409 and port section 404. At the time of transmission, the data stored in the TDMoIP payload section 1001 is copied to make generation copies. The number of data queues 40B that are set as described later with reference to FIG. 6 represents the number of generations of copies.

The following description applies to the receiving-end switching exchange 41 only. TDMoIP packets 1000 received through a reception configuration (the port section 414 and the packet SW section 419 in a protocol processing section 415) are disassembled in the TDM packet processing section 418 and reassembled into TDM data. Packet disassembly is achieved by removing the IP header 1005, UDP header 1004, timestamp 1003, and sequence number 1002. When the packets are disassembled, a sequence number comparison table 41E is searched for previously received TDMoIP packets 1000. When any existing sequence number coincides with a sequence number 41E-1 in the table, duplicate data in copied TDMoIP payload 10001 is discarded. The duplicate data is memorized in the field of payload internal data 41E-2, which will be described later with reference to FIG. 5, in accordance with a data count 1000-1-3, which will be described later with reference to FIG. 7, and length data 1000-1-2 attached to each piece of data 1000-1-1. If no existing sequence number coincides with a sequence number 41E-1 in the table, it is possible that packet loss has occurred in the IP network 50. In this instance, therefore, already delivered TDMoIP packets 1000 are reassembled into TDM data. The TDM data are multiplexed. Therefore, after all the multiplexed TDM data are obtained upon reassembly, they are converted to voice or other data. The resulting data is then transmitted to the telephone terminal 11 and PC terminal 21 through the circuit termination section 411 and TA 31.

Delay information for determining the degree of multiplicity will now be described. A delay information packet processing section 417 transmits a delay information packet 2000 from the receiving-end switching exchange 41 to the transmitting-end switching exchange 40. The delay information packet 2000 contains delay information indicative of delay time between the transmitting-end switching exchange 40 and receiving-end switching exchange 41, which is derived from a data management table 41D in the receiving-end switching exchange 41.

The transmitting-end switching exchange 40 receives the delay information packet 2000, causes a delay information packet processing section 407 to disassemble the packet and acquire the delay information 2000-1, and writes the acquired delay information 2000-1 into the data management table 40D. The delay information is then used to calculate the degree of multiplicity, which varies with the delay in the IP network.

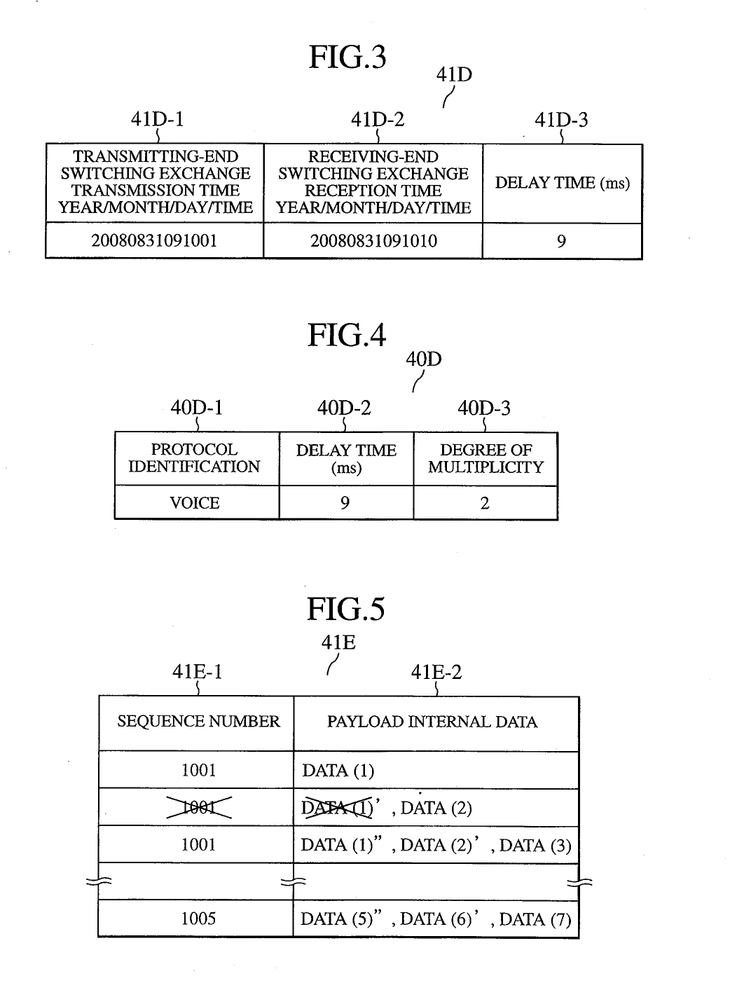

FIG. 3 is a diagram illustrating the data management table 41D for the receiving-end switching exchange 41. When a TDMoIP packet 1000 is received, a timestamp 1000-2, which will be described later with reference to FIG. 7, is stored in the field of transmitting-end switching exchange transmission time 41D-1, and the time of TDMoIP packet reception is stored in the field of receiving-end switching exchange reception time 41D-2. The difference between the above two stored values is then calculated as the delay time of the IP network and stored in the field of delay time 41D-3. The delay information packet 2000 containing the above calculation result is transmitted to the transmitting-end switching exchange 40. The delay information packet 2000 will be described later with reference to FIG. 8.

FIG. 4 is a diagram illustrating the data management table 40D for the transmitting-end switching exchange 40. When the delay information packet 2000 is received, the calculation result contained in the packet is stored in the field of delay time 40D-2. The degree of multiplicity 40D-3 is then calculated from the delay time. The degree of multiplicity of TDM data is determined from the result of calculation. In the field of protocol identification 40D-1, the aforementioned identified data type is entered. The result of protocol identification, which is based on the volume of data, may be voice data, common data such as email data or Web data, or other data such as fax data.

FIG. 5 is a diagram illustrating the sequence number comparison table 41E in the receiving-end switching exchange 41. When there is any duplicate sequence number in the field of sequence number 41E-1, duplicate data corresponding to the duplicate sequence number is discarded from the field of payload internal data 41E-2.

FIG. 6 is a diagram illustrating a data queue 40B (41B), which is in the transmitting-end switching exchange 40 or receiving-end switching exchange 41. The aforementioned data queue control section 40C (41C) can be used to preselect the number (N) of generations of data queue copies. In the example shown in FIG. 6, N=3. It means that up to three generations of copies can be made.

FIG. 7 is a diagram illustrating a TDMoIP packet 1000. The TDMoIP packet contains TDMoIP payload 1000-1, a timestamp 1000-2, a sequence number 1000-3, a UDP header 1000-4, and an IP header 1000-5. The TDMoIP payload 1000-1 is composed of the sum total of multiplexed TDM data (segment data) 1000-1-1, length values of the multiplexed TDM data, and a data count 1000-1-3. The data count 1000-1-3 indicates the size of the data queue (N or less). In the example in FIG. 6, which assumes that the data queue size N=3, the data count of the TDMoIP payload 1000-1 is 3 or less. As regards generation-copied data, two pieces of data A are multiplexed into data (1)″; two pieces of data B are multiplexed into data (2)′; and two pieces of data C are multiplexed into data (3). The timestamp 1000-2 represents the time of transmission from the transmitting-end switching exchange 40. The sequence number 1000-3 is a sequence number for packetization and assigned at the time of transmission. The UDP header 1000-4 and IP header 1000-5 are attached to the above-described elements to form a TDMoIP packet 1000. The resulting TDMoIP packet 1000 is transmitted and received over the IP network 40.

FIG. 8 is a diagram illustrating the delay information packet 2000. The delay information packet 2000 contains payload (delay information) 2000-1, a UDP header 2000-2, and an IP header 2000-3. As the packet is to be transmitted and received over the IP network 50, the IP header 2000-3 and UDP header 2000-2 are attached to the payload (delay information) 2000-1. The payload (delay information) 2000-1 is to be stored in the field of delay time 41D-3, which is described earlier with reference to FIG. 3.

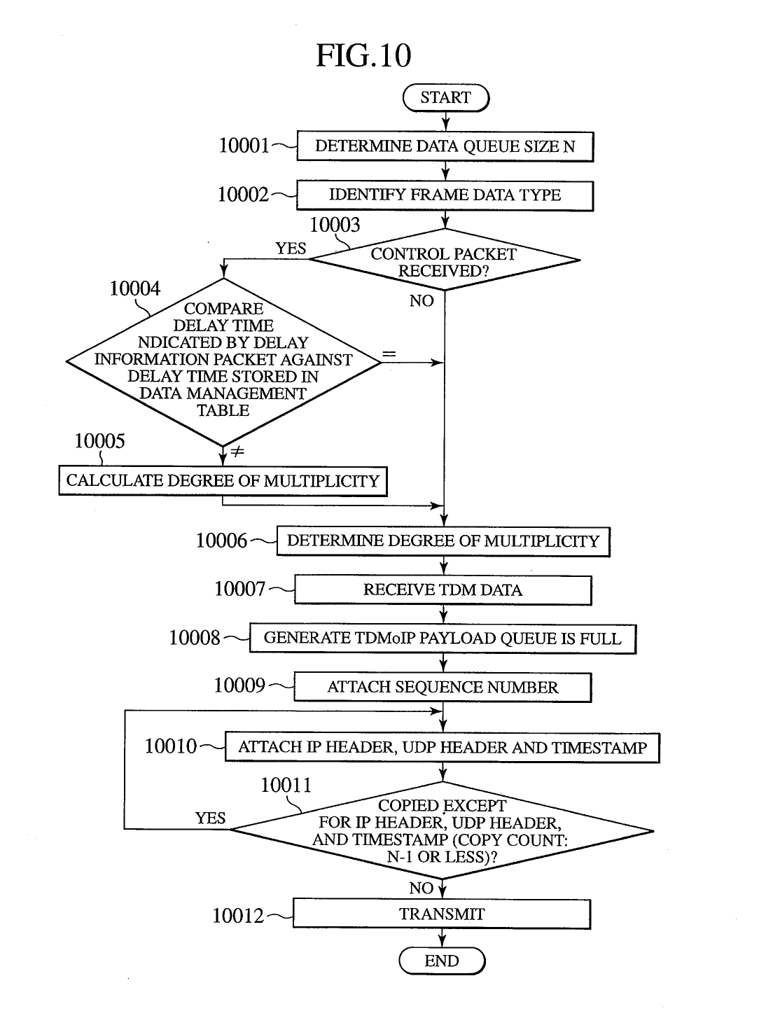

An operation of the present embodiment will now be described in detail. FIGS. 9-1 to 9-5 illustrate an operation performed by the transmitting-end switching exchange 40 in the communication system that represents an exemplary basic embodiment shown in FIG. 1. FIG. 10 is a flowchart illustrating an operation performed by the transmitting-end switching exchange 40 in the communication system that represents an exemplary basic embodiment shown in FIG. 1.

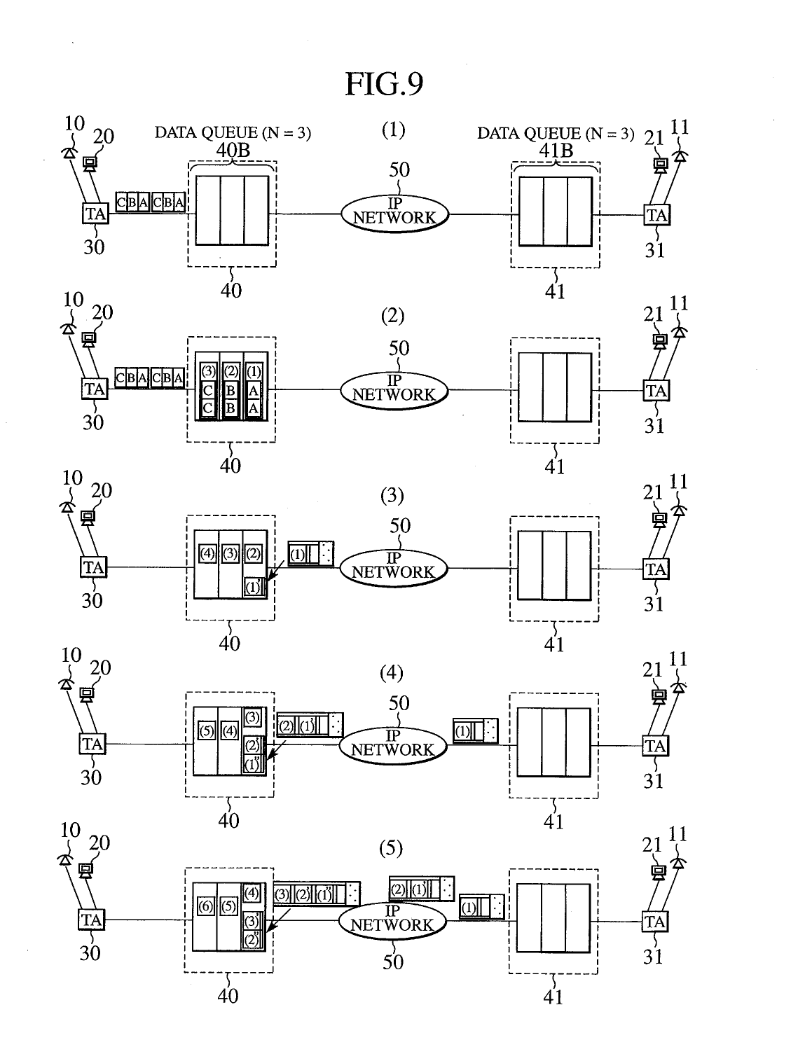

Referring to FIG. 9(1), it is assumed that the data continuously transmitted from the telephone terminal 10 and PC terminal 20 through the TA 30 is A+B+C, and that the size of the data queue 40B is set to 3 (step 10001 of FIG. 10), and further that the degree of multiplicity is 2.

Next, the protocol identification section 406 identifies the protocol type (step 10002 of FIG. 10) to determine whether voice data or common data is to be transmitted. It is temporarily assumed here that voice data is to be transmitted. If a delay information packet is received (step 10003 of FIG. 10), the delay time indicated by the delay information packet is compared against the delay time stored in the data management table (step 10004 of FIG. 10). When the delay time indicated by the delay information packet is the same as the delay time stored in the data management table, TDM data is received (step 10007 of FIG. 10) with the stored value. When, on the other hand, the delay time indicated by the delay information packet is not the same as the delay time stored in the data management table, the degree of multiplicity is newly calculated (step 10005 of FIG. 10) and determined (step 10006 of FIG. 10) before TDM data reception (step 10007 of FIG. 10).

Referring to FIG. 9(2), TDMoIP payload is formed. As the size of the data queue 40B is 3, the queue size is 3. Therefore, up to three generations of TDM data are stored in the payload 1000-1 within a TDMoIP packet as detailed later with reference to FIG. 9(5). Two pieces of data A multiplexed into data (1), two pieces of data B multiplexed into data (2), and two pieces of data C multiplexed into data (3) are stored as individual payload data 1000-1-1 (step 10008 of FIG. 10). Further, data length values 1000-1-2 and a data count 1000-1-3 are attached to each piece of payload data. As it is assumed that the data queue size is 3, the value 3 is stored as the data count.

Referring to FIG. 9(3), TDMoIP packetization is performed. In addition, a copy is made at the time of data transmission. The data queue 20A has a First-In-First-Out (FIFO) structure, stores data (2) in the first queue position, and sequentially stores data (3) and data (4).

A data length value 1000-1-2, a data count 1000-1-3, a sequence number (step 10009 of FIG. 10), an IP header, a UDP header, and a timestamp (step 10010 of FIG. 10) are attached to data (1). Data (1) is then converted to a TDMoIP packet. When the TDMoIP packet is to be transmitted (step 10012 of FIG. 10), data (1) is copied (step 10011 of FIG. 10). Data (1)′, which is a copy of data (1), is stored in the first queue position (data (1)′ and data (2)).

Referring to FIG. 9(4), a copy is made at the time of transmission in the same manner as indicated in FIG. 9(3). The data queue 40B stores data (3) in the first queue position, and sequentially stores data (4) and data (5). Data (1)′ and data (2) are handled as single payload data. A data length value 1000-1-2, a data count 1000-1-3, a sequence number (step 10009 of FIG. 10), an IP header, a UDP header, and a timestamp (step 10010 of FIG. 10) are attached to the single payload data. The single payload data is then converted to a TDMoIP packet. When the TDMoIP packet is to be transmitted (step 10011 of FIG. 10), data (1)′ and data (2) are copied (step 10012 of FIG. 10). Data (1)″ and data (2)′, which are copies of data (1)′ and data (2), respectively, are stored in the first queue position (data (1)″, data (2)′, and data (3)).

Referring to FIG. 9(5), N (3 in FIG. 9(5)) copies are made of queued data. The data queue 40B stores data (4) in the first queue position, and sequentially stores data (5) and data (6). Data (1)″, data (2)′, and data (3) are handled as single payload data. A data length value 1000-1-2, a data count 1000-1-3, a sequence number (step 10009 of FIG. 10), an IP header, a UDP header, and a timestamp (step 10010 of FIG. 10) are attached to the single payload data. The single payload data is then converted to a TDMoIP packet. When the TDMoIP packet is to be transmitted (step 10012 of FIG. 10), data (2)′ and data (3) are copied (step 10011 of FIG. 10). Data (2)″ and data (3)′, which are copies of data (2)′ and data (3), respectively, are stored in the first queue position (data (2)″, data (3)′, and data (4)). Here, as it is assumed that the size of the data queue 40B is 3 (N=3), it is possible to copy up to three generations, namely, up to three successive data sequentially obtained upon TDMoIP payload generation. As is the case with identification based on data type and the degree of multiplicity based on delay, an object is to provide increased network efficiency by increasing the packet size (payload size). Sequence number assignment is performed in such a manner that the same sequence number is attached to all generations of the same data.

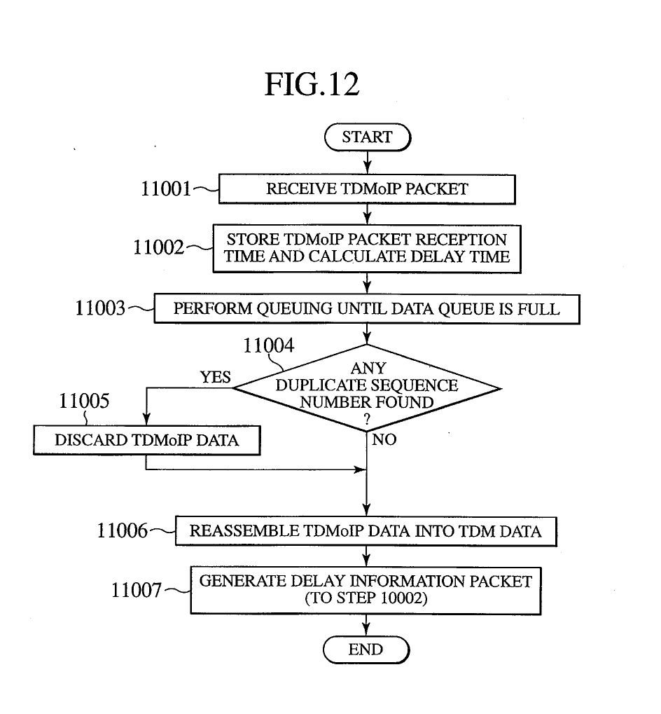

FIGS. 11-1 to 11-5 illustrate an operation performed by the receiving-end switching exchange 41 in the communication system that represents an exemplary basic embodiment shown in FIG. 1. FIG. 12 is a flowchart illustrating an operation performed by the receiving-end switching exchange 41 in the communication system that represents an exemplary basic embodiment shown in FIG. 1.

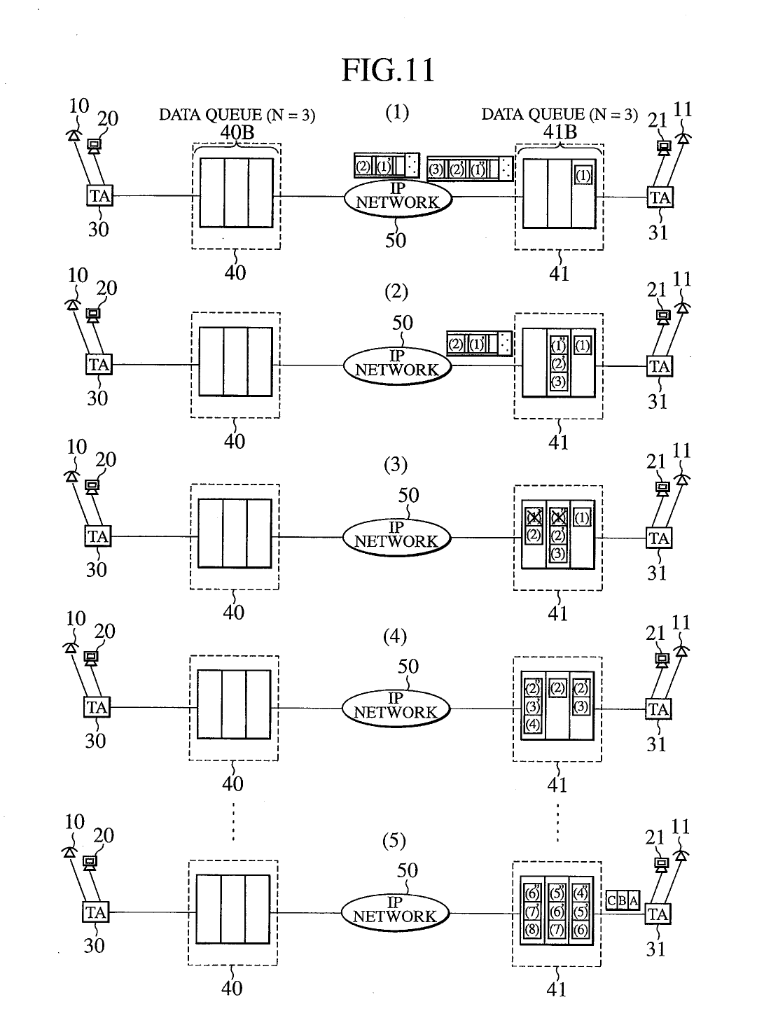

Referring to FIG. 11(1), the receiving-end switching exchange 41 receives a TDMoIP packet 1000 (step 11001 of FIG. 12), stores the reception time of the received TDMoIP packet 1000 in the data management table (41D-2 in FIG. 3), and calculates the delay time (step 11002 of FIG. 12). The data queue 41B stores data (1) (step 11003 of FIG. 12), which is obtained by disassembling the TDMoIP packet 1000. Packet disassembly is achieved by removing the IP header 1005, UDP header 1004, timestamp 1003, and sequence number 1002. At the time of packet disassembly, the sequence number comparison table 41E is searched for previously received TDMoIP packets 1000. If any existing sequence number coincides with a sequence number 41E-1 in the table, duplicate data in copied TDMoIP payload 10001 is discarded. The duplicate data is memorized in the field of payload internal data 41E-2, which will be described later with reference to FIG. 5, in accordance with a data count 1000-1-3, which is shown in FIG. 7, and length data 1000-1-2 attached to each piece of data 1000-1-1. If no existing sequence number coincides with a sequence number 41E-1 in the table, it is possible that packet loss has occurred in the IP network 50. In this instance, therefore, already delivered TDMoIP packets 1000 are reassembled into TDM data. In the resulting state, only data (1) is placed in the first queue position after TDMoIP packet disassembly.

Referring to FIG. 11(2), the order in which TDMoIP packets 1000 arrive at the receiving-end switching exchange is not guaranteed because the IP network 50 lies between the switching exchanges 40, 41. It is therefore assumed that the third TDMoIP packet 1000 transmitted from the transmitting-end switching exchange 40 is queued so as to store data (1)″, data (2)′, and data (3) in the second queue position (step 11003 of FIG. 12), as is the case described with reference to FIG. 11(1).

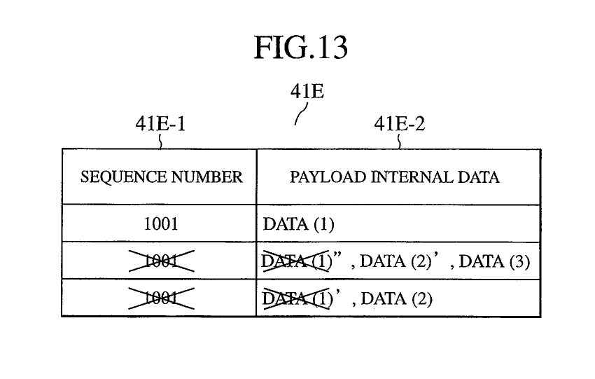

Referring to FIG. 11(3), any duplicate received packet is discarded in accordance with a sequence number. As is the case described with reference to FIG. 11(1), the data queue 41B stores data (1) in the first queue position, data (1)″, data (2)′, and data (3) in the second queue position, and data (1)′ and data (2) in the third queue position (step 11003 of FIG. 12). Next, the sequence numbers are compared with each other (step 11004 of FIG. 12). Copies of data (1) (data (1)″ and data (1)′), which are placed in the second and third queue positions as indicated in the field of payload internal data 41E-2, are discarded from the sequence number comparison table 41E shown in FIG. 13 because they are duplicated and assigned the same sequence number (1001).

Referring to FIG. 11(4), the data queue 41B stores data (2)′ in the first queue position because data (1) is deleted, stores data (2) in the second queue position, and stores data (2)″, data (3)′, and data (4) in the third queue position.

Referring to FIG. 11(5), it is assumed that TDMoIP packets 1000 are sequentially received, and that data (2) to (3) have the same sequence number. In such an instance, the data queue 41B stores data (4)″, data (5)′, and data (6) in the first queue position, stores data (5)″, data (6)′, and data (7) in the second queue position, and stores data (6)″, data (7)′, and data (8) in the third queue position. As all the data required for data (1) to (3) are readied, they are reassembled into data (A+B+C) for one frame of TDM data (step 11006 of FIG. 12). After completion of TDM data reassembly, the delay information packet is transmitted to the receiving-end switching exchange (step 11007 of FIG. 12).

### Second Embodiment

A second embodiment of the present invention will now be described. FIGS. 14-1 to 14-4 illustrate a delay information packet and an operation performed by the transmitting-end switching exchange. The second embodiment will also be described with reference to FIG. 10 which is a flowchart illustrating an operation performed by the transmitting-end switching exchange. For illustration purposes, it is assumed that TDMoIP packet processing is performed with the data queue size set to 3 (step 10001 of FIG. 10) and the degree of TDM data multiplicity set to 3.

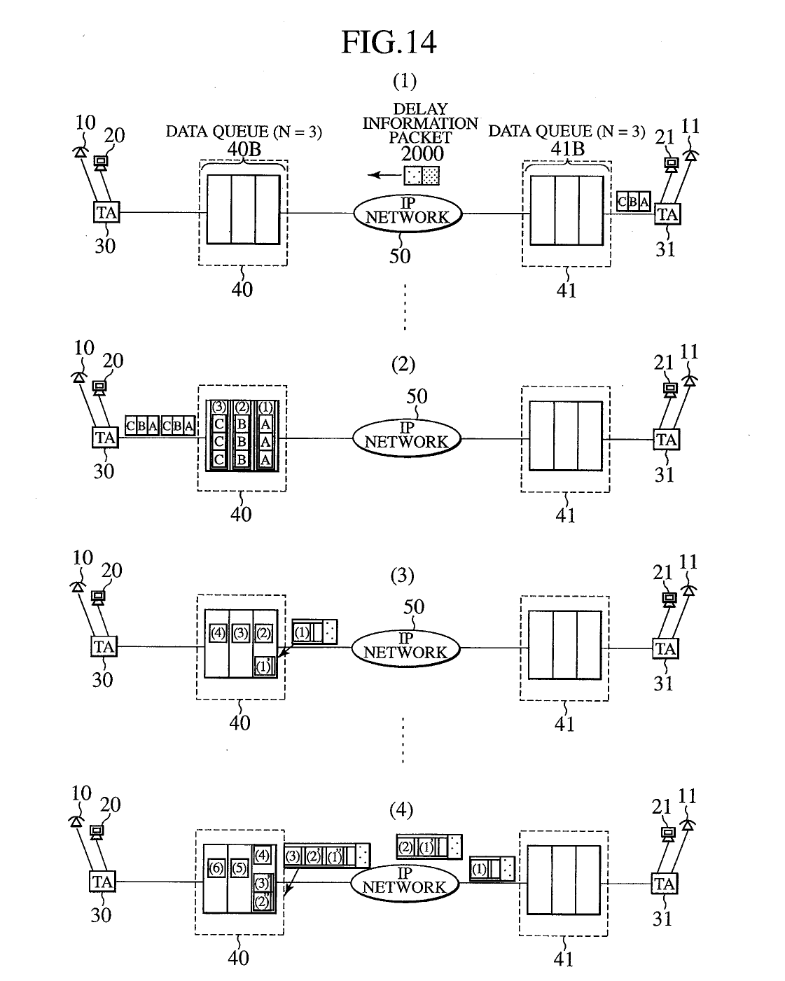

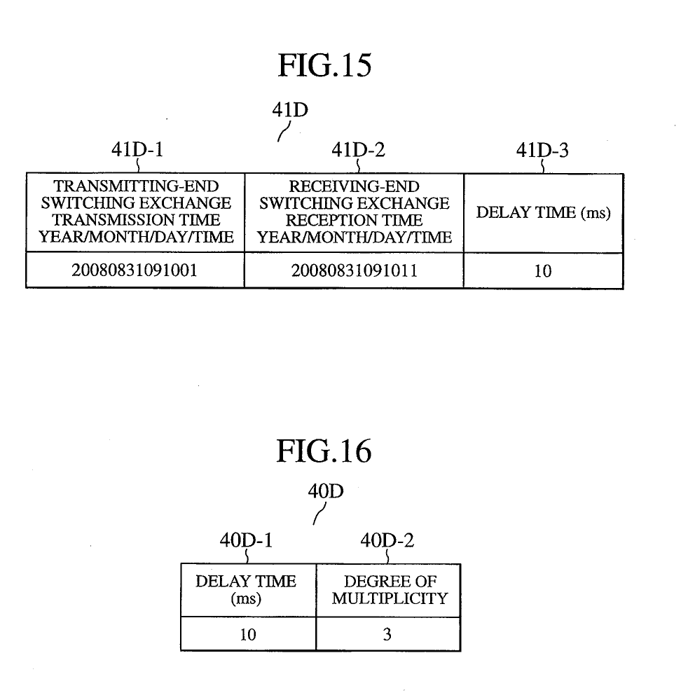

Referring to FIG. 14(1), the delay time of the IP network 50, which is calculated from the data management table 41D shown in FIG. 15, is 10 ms. The receiving-end switching exchange 41 transmits the delay time to the transmitting-end switching exchange 40 by using a delay information packet 2000. Upon receipt of the delay information packet 2000 (step 10003 of FIG. 10), the transmitting-end switching exchange 40 memorizes the delay time (10 ms), compares it against the delay time stored in the data management table (step 10004 of FIG. 10), calculates the degree of multiplicity 40D-3 from the delay time (step 10004 of FIG. 12), and memorizes the value 3 instead of the value 2 (step 10005 of FIG. 12), as the degree of multiplicity (FIG. 16).

Referring to FIG. 14(2), the degree of multiplicity is set to 3. As the degree of multiplicity is 3 and the size of the data queue 40B is 3 (N=3), up to three generations of packets are stored in the TDMoIP packet internal payload 1000-1. Three pieces of data A multiplexed into data (1), three pieces of data B multiplexed into data (2), and three pieces of data C multiplexed into data (3) are stored as individual payload data (step 10008 of FIG. 10). Further, data length values 1000-1-2 and a data count 1000-1-3 are attached to each piece of payload data. As it is assumed that the data queue size is 3, the value 3 is stored as the data count.

Referring to FIG. 14(3), TDMoIP packetization is performed. In addition, a copy is made at the time of data transmission. The data queue 40B stores data (2) in the first queue position, and sequentially stores data (3) and data (4). A data length value 1000-1-2, a data count 1000-1-3, a sequence number (step 10009 of FIG. 10), an IP header, a UDP header, and a timestamp (step 10010 of FIG. 10) are attached to data (1). Data (1) is then converted to a TDMoIP packet. When the TDMoIP packet is to be transmitted (step 10012 of FIG. 10), data (1) is copied (step 10011 of FIG. 10). Data (1)′, which is a copy of data (1), is stored in the first queue position (data (1)′ and data (2)). Subsequently, data (1), data (2), and data (3) are sequentially copied (in the same manner as indicated in FIG. 9(4)).

Referring to FIG. 14(4), N copies are made of queued data. The data queue 40B stores data (4) in the first queue position, and sequentially stores data (5) and data (6). Data (1)″, data (2)′, and data (3) are handled as single payload data. A data length value 1000-1-2, a data count 1000-1-3, a sequence number (step 10009 of FIG. 10), an IP header, a UDP header, and a timestamp (step 10010 of FIG. 10) are attached to the single payload data. The single payload data is then converted to a TDMoIP packet. When the TDMoIP packet is to be transmitted (step 10012 of FIG. 10), data (2)′ and data (3) are copied (step 10011 of FIG. 10). Data (2)″ and data (3)′, which are copies of data (2)′ and data (3), respectively, are stored in the first queue position (data (2)″, data (3)′, and data (4)).

FIGS. 17-1 to 17-3 illustrate an operation performed by the receiving-end switching exchange 41 in the communication system that represents an exemplary basic embodiment shown in FIG. 1. The following example illustrates a case where a TDMoIP packet 1000 is lost in the IP network 50. The example will also be described with reference to FIG. 12, which is a flowchart illustrating an operation performed by the transmitting-end switching exchange.

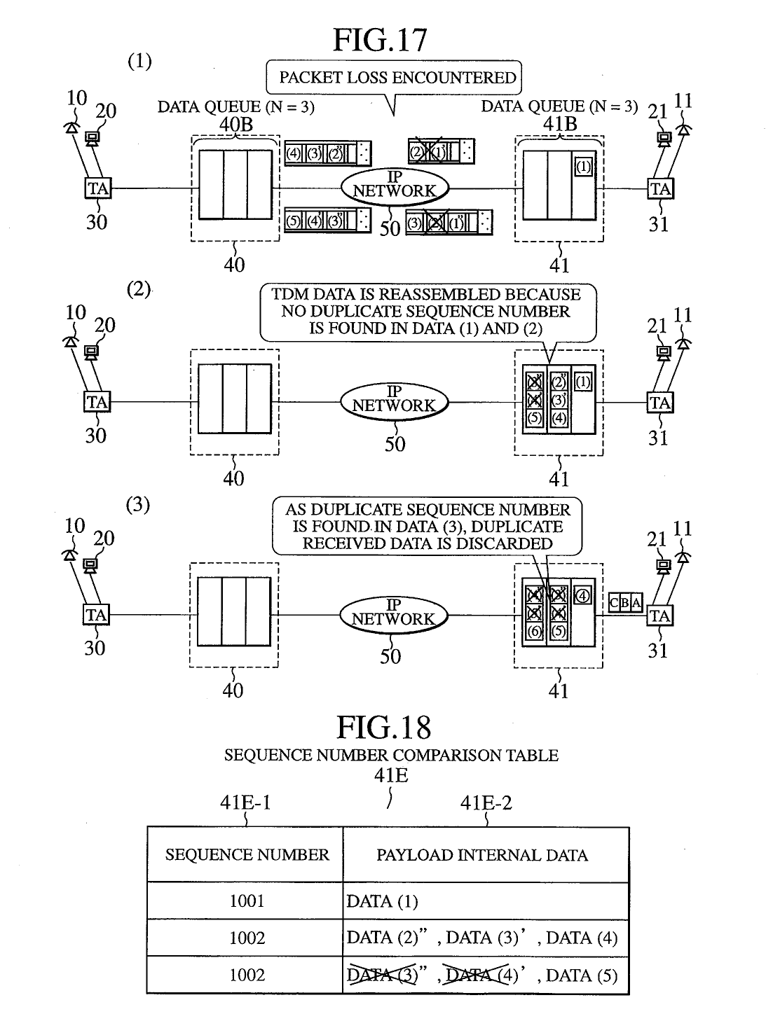

Referring to FIG. 17(1), it is assumed that a TDMoIP packet 1000 containing data (1) is already received by the receiving-end switching exchange 41. The reception time of the TDMoIP packet 1000 is stored in the data management table to calculate the delay time (step 11002 of FIG. 12). Here, as indicated in FIG. 11(1), which illustrates the first embodiment, the data queue 41B stores data (1) (step 11003 of FIG. 12) after disassembly of the TDMoIP packet 1000. It is now assumed that a TDMoIP packet 1000 containing data (1)′ and data (2) and a TDMoIP packet 1000 containing data (1)″, data (2)′, and data (3) are lost in the IP network 50.

Referring to FIG. 17(2), a TDMoIP packet 1000 containing data (2)″, data (3)′, and data (4) and a TDMoIP packet 1000 containing data (3)″, data (4)′, and data (5) are delivered to the data queue because the TDMoIP packet 1000 containing data (1)′ and data (2) and the TDMoIP packet 1000 containing data (1)″, data (2)′, and data (3) are lost. In the same manner as described with reference to FIG. 17(1), the TDMoIP packets 1000 are disassembled to compare the sequence numbers (step 11004 of FIG. 12). As the sequence number comparison table 41E indicates that the sequence number 1001, which is in the field of sequence number 41E-1, is not duplicated, a TDMoIP packet 1000 containing data (1) is reassembled into TDM data.

The sequence number 1002, on the other hand, is duplicated. Therefore, data (3)″ and data (4)′, which are the copies of data (3) and data (4) and placed in the third queue position of the payload internal data 41E-2, are discarded (step 11005 of FIG. 12). As data (2) and (3) are readied in the above-mentioned step in addition to data (1), they are reassembled into data (A+B+C) for one frame of TDM data (step 11006 of FIG. 12). After completion of TDM data reassembly, the delay information packet 2000 is transmitted to the transmitting-end switching exchange 40 (step 11007 of FIG. 12).

The exemplary configuration according to the first or second embodiment described above makes it possible to provide enhanced reliability in packet recovery by making generation copies of TDM data and increase the transfer efficiency and the bandwidth efficiency of low-delay transfer in consideration of the delay in an IP network and the type of TDM data when TDMoIP packet loss occurs in the IP network 50 in a situation where a network system and a switching exchange are used to handle both an ISDN and IP network.

What is claimed is:

1. A network system comprising:
a transmitter for transmitting packet data to a network, the packet data being obtained by packetizing time-division-multiplexed data; and
a receiver for receiving the packet data;
wherein the transmitter includes
a first memory section for storing segment data, the segment data being obtained by segmenting the time-division-multiplexed data,
a control section for controlling the generation of duplicate data from the segment data,
a first packet processing section for multiplexing the segment data and converting the multiplexed segment data to packet data, and
a transmission section for transmitting the packet data to the network, and
wherein the receiver includes
a reception section for receiving the packet data, and
a second packet processing section for converting the received packet data to time-division-multiplexed data.

2. The network system according to claim 1, wherein the first packet processing section variably sets the degree of multiplicity of the segment data.

3. The network system according to claim 1, wherein the control section provides control over generation copies of the segment data.

4. The network system according to claim 1, wherein the second packet processing section judges whether the received packet data is redundant.

5. The network system according to claim 4, wherein the receiver further includes a first table for storing information about a sequence number contained in the packet data, the first table being referenced by the second packet processing section for judgment whether the received packet data is redundant.

6. The network system according to claim 1, wherein the second packet processing section judges whether the received packet data is redundant, and discards redundant packet data.

7. The network system according to claim 1, wherein the transmitter further includes a protocol identification section for identifying the protocol of the time-division-multiplexed data.

8. The network system according to claim 1, wherein the control section controls the generation of the duplicate data in accordance with a data queue in the memory section.

9. The network system according to claim 1, wherein the transmitter receives the time-division-multiplexed data through an ISDN, and wherein the network is an IP network.

10. The network system according to claim 1, wherein the first packet processing section multiplexes the segment data and then converts the multiplexed segment data to the packet data.

11. The network system according to claim 1, wherein the control section exercises control so as to generate duplicate data in the order in which the segment data is prepared, the segment data corresponding to payload of the packet data.

12. The network system according to claim 1,
wherein the receiver further includes a third packet processing section for generating a delay information packet in accordance with the time difference between transmission by the transmitter and reception by the receiver, and
wherein the transmitter further includes a fourth packet processing section for calculating the degree of multiplicity of the segment data in accordance with the delay information packet when receiving the delay information packet from the receiver.

13. The network system according to claim 12, wherein the third packet processing section generates the delay information packet in accordance with the time difference between a transmission timestamp of the transmitter and the packet data reception time of the receiver.

14. The network system according to claim 1, wherein the second packet processing section removes a header, a timestamp, and a sequence number from the packet data and converts the packet data to time-division-multiplexed data.

15. The network system according to claim 1, wherein the receiver further includes a second memory section for storing the time-division-multiplexed data generated by the second packet processing section.

16. A communication method for using a transmitter for transmitting packet data to a network, the packet data being obtained by packetizing time-division-multiplexed data, a receiver for receiving the packet data, and a network for connecting the transmitter and the receiver, the communication method comprising the steps of:
segmenting the time-division-multiplexed data received by the transmitter;
storing the resulting segment data in a first memory section;
reading the segment data from the first memory section and generating duplicate data;
causing a first packet processing section to multiplex the segment data and convert the multiplexed segment data to packet data;
transmitting the packet data from the transmitter to the network; and
causing a second packet processing section to convert the packet data to time-division-multiplexed data, the packet data being received by the receiver through the network.

17. The communication method according to claim 16, wherein the degree of multiplicity of the segment data is variably set.

18. The communication method according to claim 16, wherein the duplicate data is obtained by making a generation copy of the segment data.

19. The communication method according to claim 16, wherein the second packet processing section judges whether the received packet data is redundant.

20. The communication method according to claim 16, wherein the first packet processing section multiplexes the segment data and converts the multiplexed segment data to the packet data.
